(19) United States
(12) Patent Application Publication
(10) Pub. No.: US 2010/0077550 A1
(43) Pub. Date: Apr. 1, 2010

(54) METHOD FOR COATING A FRAME OF A STRETCHER

(75) Inventor: Andrea BERTOZZI, Parma (IT)

Correspondence Address: Pearne & Gordon LLP, 1801 East 9th Street, Suite 1200, Cleveland, OH, 44114-3108, US

(73) Assignee: ME.BER. S.R.L., Parma (IT)

(21) Appl. No.: 12/563,767

(22) Filed: Sep. 21, 2009

(30) Foreign Application Priority Data
Sep. 23, 2008 (IT) PR2008A000057

(51) Int. Cl. A61G 1/00; B29C 41/22

(52) U.S. Cl. 5/625; 264/250

(57) ABSTRACT

Method for coating a frame (18) of a stretcher (1) by moulding a first layer (13) of rigid plastic material onto the frame (18) and subsequently moulding a second layer (14) of soft plastic material onto said first layer (13).

The present invention has for its subject a method for coating a frame of a stretcher, particularly for use in the medical emergency sector.

As is well-known, there exist various types of stretchers, differentiated on the basis of their use. For example, so-called “scoop” stretchers are typically used in first-aid operations for non-traumatic recovery of patients. Such stretchers do not also constitute an immobilisation device once recovery has been effected, unlike stretchers of “spinal” type, which do constitute a device for recovery and immobilisation. There are also self-loading stretchers, paediatric stretchers and folding and non-folding chair stretchers.

The stretchers available on the market have an area for accommodating the patient in an outstretched or seated position and means for moving or activating the stretcher. For example, spinal or scoop stretchers are known with a frame in aluminium or aluminium alloys, and length adjustable according to the height of the user. Such stretchers have longitudinal symmetry, with grips arranged perimetrally to the stretcher itself.

The principal disadvantage of the currently known solutions is connected with the stretchers' lack of comfort. The patient, in fact, lies outstretched directly on the frame, which is made of metal and therefore rigid, and as a result is hard and uncomfortable. The known stretchers, moreover, are found to be uncomfortable for the health personnel to move, for example because of the slipperiness of the grips.

A further disadvantage of the stretchers on the market concerns the high cost and time taken for repairing stretchers. Often, furthermore, in the case of damage to certain parts, it is necessary to replace the stretcher completely.

In this context, the technical task of the present invention is to propose a method for coating a frame of a stretcher, which overcomes the disadvantages of the known art mentioned above.

In particular, it is an object of the present invention to make available a method of coating a frame of a stretcher so as to improve the ergonomics for the user and for the health personnel.

Another object of the present invention is to propose a stretcher (made with the method described) which, in case of damage, is repairable in a short time and at moderate cost.

The declared technical task and the specified objects are substantially achieved by a method for coating a frame of a stretcher comprising the technical characteristics set forth in one or more of the attached claims.

Further characteristics and advantages of the present invention will become clearer from the indicative, and therefore non-limiting, description of a preferred but not exclusive embodiment of a stretcher according to the method described, as illustrated in the attached drawings, in which:

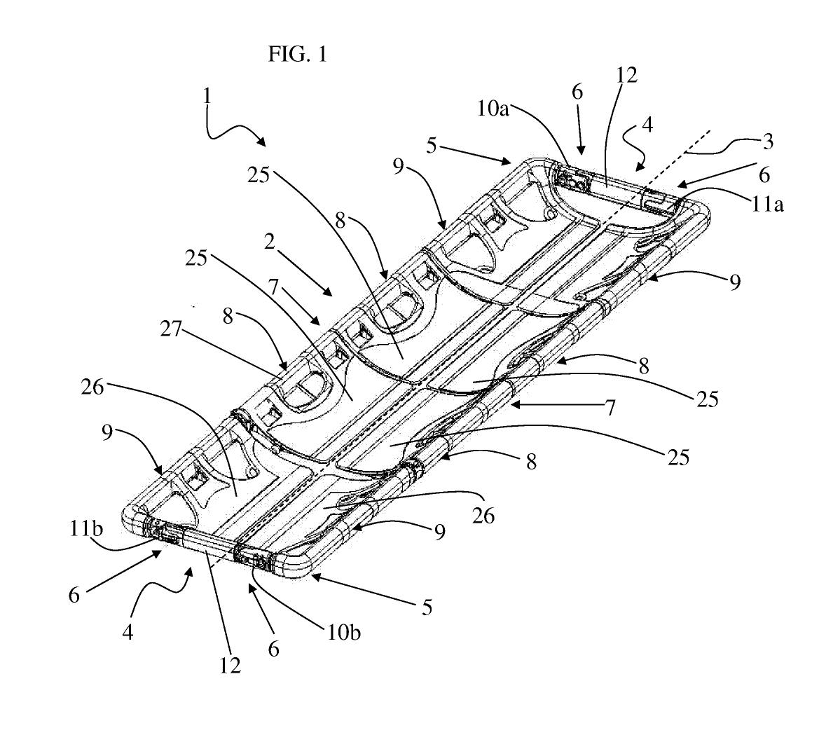

FIG. 1 illustrates a stretcher according to the present invention, in a perspective view;

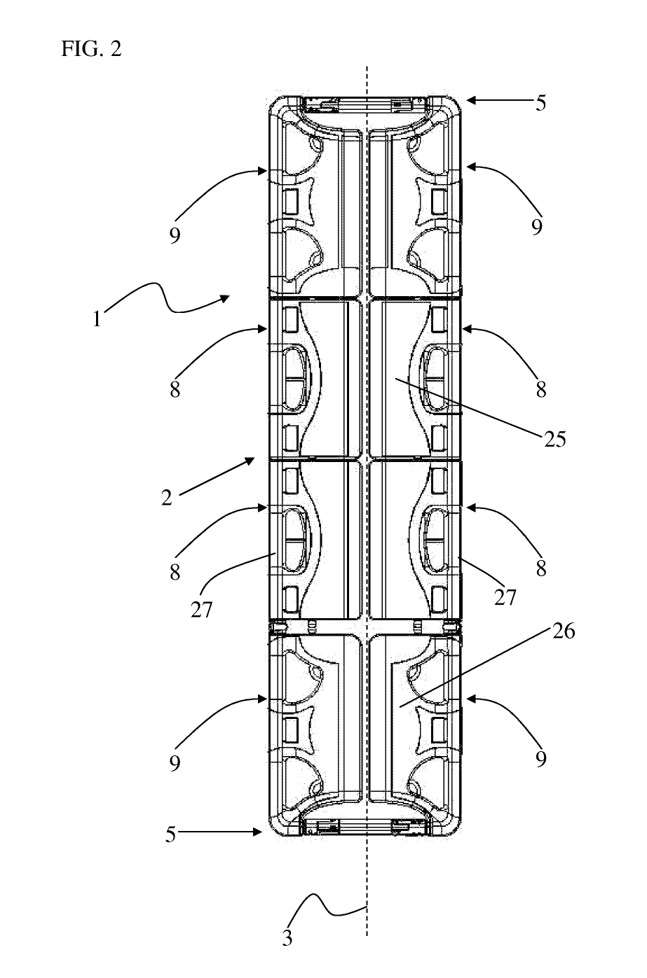

FIG. 2 illustrates the stretcher of FIG. 1, in a top view;

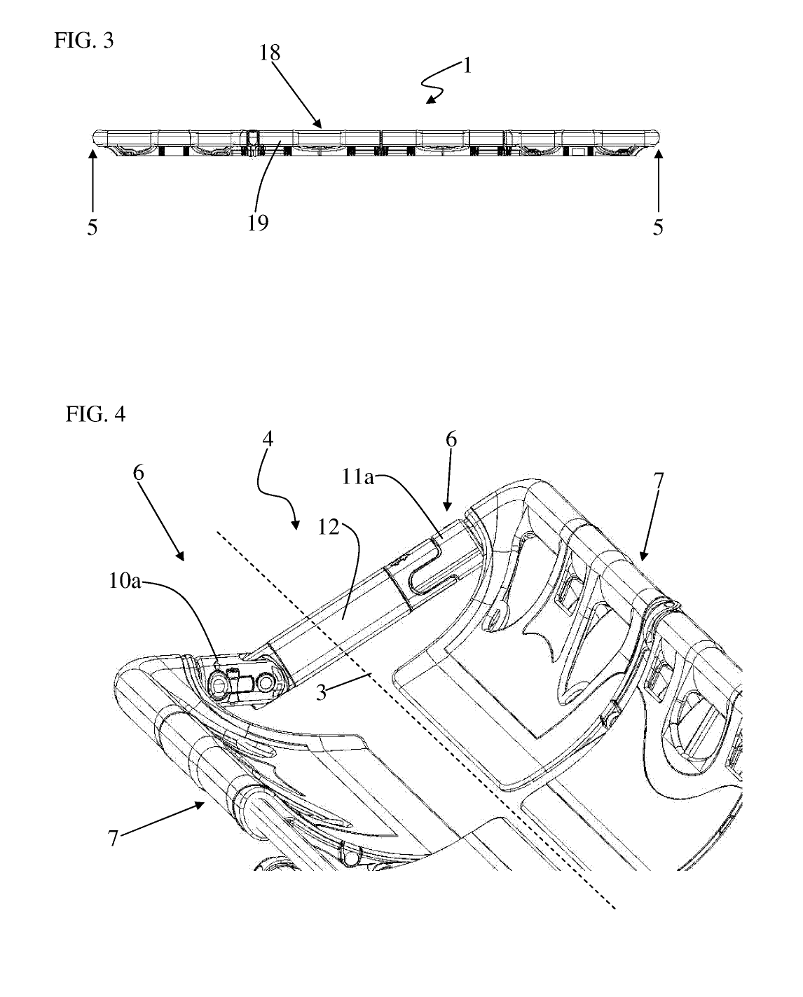

FIG. 3 illustrates the stretcher of FIG. 1, in a side view;

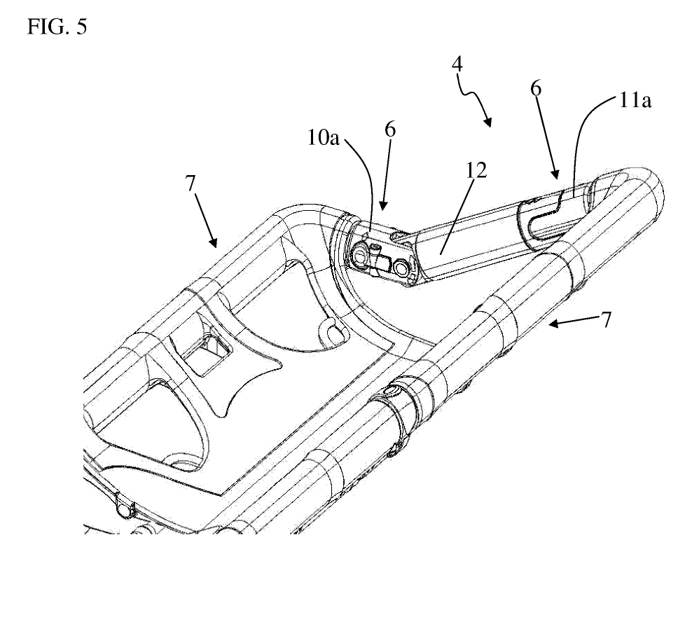

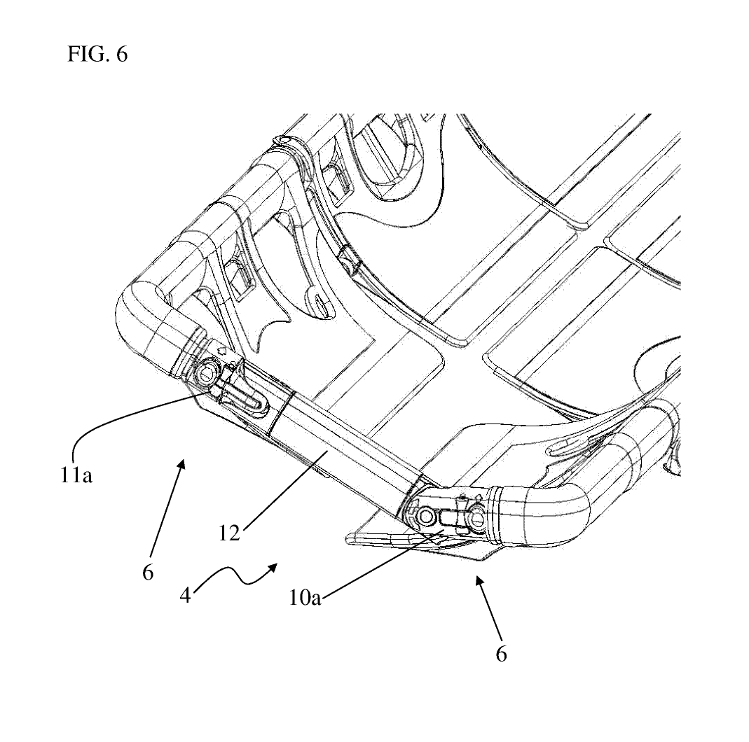

FIGS. 4, 5 and 6 illustrate details of the stretcher of FIG. 1, in three perspective views;

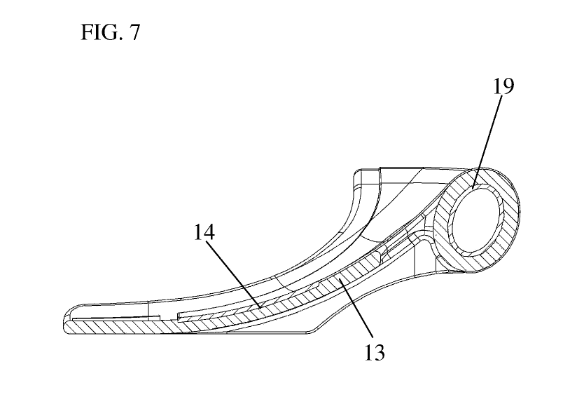

FIG. 7 illustrates a detail of the stretcher of FIG. 1, in a cutaway view.

With reference to the figures, n. 1 indicates a stretcher, in particular for use in the medical emergency sector. For example, such a stretcher 1 is used for the recovery of a user in first aid operations and as an immobilisation device. Alternatively, the stretcher 1 can be of “spinal” type. Alternatively, the stretcher 1 can be a self-loading stretcher or a paediatric stretcher or a folding chair stretcher.

The stretcher 1 comprises a section 2 for housing the user along a longitudinal axis 3. In particular, the user lies outstretched along this longitudinal axis 3. The stretcher 1 is furthermore provided with activation means 4 located at two opposed ends 5 of the housing section 2.

Originally, the activation means 4 comprise articulating means 6 for the stretcher 1. Advantageously, these articulating means 6 are operatively active on the housing section 2 so as to modify its operative conformation for supporting an outstretched user by varying the mutual orientation of two portions 7 (or half-shells) of the housing section 2, connected by the articulating means 6. Preferably, these portions 7 of the housing section 2 are symmetrical with respect to the longitudinal axis 3 and have planar extension. In particular, the planes identified by said portions 7 intersect at the longitudinal axis 3 and thus form an angle. The articulating means 6 allow the angle to be varied in such a way as to adapt the stretcher 1 to various recovery situations.

Advantageously, the housing section 2 is made up of a plurality of identical central modules 8 and of two outer modules 9 which, too, are identical. In particular, these outer modules 9 house the activation means 4. Preferably, there are two of the central modules 8, each formed of two central submodules 25, in such a way as to house respectively the lumbar and dorsal areas. The external modules 9, each formed of two external submodules 26, house respectively the cervical area and the feet.

Originally, the articulating means 6 of the stretcher 1 comprise a first articulated element 10a and a second articulated element 10b for mutually inclining the two portions 7 of the housing section 2 in a desired configuration. In particular, this desired configuration corresponds to a predetermined value for the angle formed by the planes comprising said portions 7.

Originally, the articulating means 6 of the stretcher 1 also comprise a first locking element 11a and a second locking element 11b in order to lock the portions 7 in the desired configuration. In particular, the portions 7 are locked in such a way that the predetermined value for the angle formed by the planes comprising the portions 7 is maintained.

Originally, the articulating means 6 are off-centre with respect to the longitudinal axis 3 in order to facilitate recovering the user. Advantageously, the first articulated element 10a and the first locking element 11a are antisymmetric in relation to the second articulated element 10b and the second locking element 11b with respect to the longitudinal axis 3.

The stretcher 1 has a frame 18, preferably metallic. More preferably, the frame 18 is made of a non-magnetic metallic material, for example of aluminium or aluminium alloy. For example, the frame 18 is made up of tubular sections 19 of known type.

Originally, the frame 18 has applied to it a first layer 13 of rigid plastic material to structurally shape the stretcher 1. In particular, the frame 18 is positioned inside a first mould in which the first layer 13 is moulded onto said frame 18. Preferably, the first layer 13 is made of heat-resistant material. More preferably, this first layer 13 is made of thermoplastic polymer, for example of POLIFOR.

Originally, the first layer 13 has applied to it a second layer 14 of soft plastic material so as to promote the comfort of the user supported on the stretcher 1. In particular, the frame 18 coated in the first layer 13 is positioned inside a second mould in which the second layer 14 is moulded onto the first layer 13. Preferably, the second layer 14 is made of heat-resistant material. More preferably, this second layer 14 is made of thermoplastic elastomer, for example of FORPRENE.

Preferably, the activation means 4 for the stretcher 1 comprise at least two gripping areas 12 for grasping the stretcher 1. Preferably, the two gripping areas 12 are respectively interposed between the first articulated element 10a and the first locking element 11a, and between the second articulated element 10b and the second locking element 11b. Preferably, the stretcher 1 comprises auxiliary gripping areas 27 located perimetrally to the stretcher 1 and parallel to the longitudinal axis 3. Preferably, the gripping areas 12 and the auxiliary gripping areas 27 are located on the second layer 14.

Advantageously, the stretcher 1 is provided with a radio frequency identification device (commonly known by the acronym RFID, from the English “Radio Frequency Identification”). Preferably, the radio frequency identification device is a passive electronic circuit. In particular, the radio frequency identification device is used for communicating identification parameters of the stretcher 1. For example, these identification parameters comprise the times and dates of entry and exit of stretcher 1 from the hospital departments, the batch to which it belongs and the date of purchase of the stretcher 1 and the date specified for the next maintenance of the stretcher 1 itself.

Preferably, the stretcher 1 has a thickness of about 5 cm, a width of about 43 cm and a length adjustable in known manner from a minimum of about 165 cm to a maximum of about 201 cm depending on the height of the user. The weight of the stretcher 1 is about 11 kg and its carrying capacity is about 150 kg. Preferably, the stretcher 1 is foldable, and in folded configuration has a length of 120 cm and a thickness of 9 cm.

Preferably, identifying elements can be applied to the stretcher 1. For example, these identifying elements consist of adhesive labels attached to lowered areas of the stretcher 1. In particular, these adhesive labels carry the trademark of the health institution to which the stretcher 1 belongs. Alternatively or in addition, these adhesive labels carry advertising information, for example for pharmaceutical products. Alternatively or in addition, the adhesive labels can carry the names of the organisations or individual people who donated stretcher 1.

Preferably, the first layer 13 and the second layer 14 have customisable colours which facilitate the further identification of stretcher 1. For example, different colours can indicate different departments of the same health institution to which the stretcher 1 belongs. The user is held in the stretcher 1 by means of restraining belts of known type.

The operation of the stretcher produced according to the method described in the present invention is as set forth below. In operations to recover the user, for example in first aid, a stretcher 1 for example of “scoop” type is used. The stretcher 1 is lifted and transported into proximity with the user by grasping the gripping areas 12 and the auxiliary gripping areas 27. The length of the stretcher 1 is adjusted according to the height of the user to be recovered.

To adapt to different recovery situations (narrow spaces, shape of the supporting surface etc.), an operator acts on the first articulated element 10a and on the second articulated element 10b, so as to incline the portions 7 in the desired configuration. The weight of the patient on the housing section 2 activates the first locking element 11a and the second locking element 11b in such a way that said portions 7 remain locked in the desired configuration. In this way, the user can be transported in a non-traumatic manner to the health institution, and the stretcher 1 can function also as an immobilisation device after administration of first aid. The characteristics of the stretcher according to the present invention are clear from the description given above, as also are the advantages.

In particular, thanks to the presence of the first rigid coating layer, the structure of the stretcher is well profiled. At the same time, the presence of the second coating layer in soft plastic material makes the support for the user on the stretcher more comfortable. This layered structure of the stretcher also allows it to be used as an immobilisation as well as a recovery device, ensuring good ergonomics for the user.

Furthermore, both the gripping areas and the auxiliary gripping areas are formed in soft plastic material, reducing the slipperiness of the contact surfaces of the stretcher. In this way, the stretcher is also ergonomic for the health personnel.

In addition, in the event of damage, the stretcher is easily repairable. It is actually possible to replace just the damaged module (central or external), thus reducing the cost and the time taken by comparison with stretchers currently on the market.

1. Method for coating a frame of a stretcher, characterised by comprising the stages of:
applying to the frame a first layer of rigid plastic material to structurally shape the stretcher;
applying to said first layer a second layer of soft plastic material to favour supporting a user on the stretcher.

2. Method according to claim 1, wherein the stage of applying the first layer to the frame includes the stage of positioning said frame inside a first mould and the stage of moulding said first layer onto said frame.

3. Method according to claim 2, wherein the stage of applying the second layer to the first layer includes the stage of positioning the frame coated with the first layer inside a second mould and the stage of moulding said second layer onto said first layer coating the frame.

4. Method according to claim 1, wherein the frame is metallic.

5. Method according to claim 1, wherein the first layer is made of thermoplastic polymer.

6. Method according to claim 1, wherein the second layer is made of thermoplastic elastomer.

7. Method according to claim 1, wherein said second layer includes at least two areas for gripping the stretcher.

8. Stretcher having a frame coated according to the method described in claim 1.

9. Stretcher according to claim 8 having a section for housing a user, said stretcher being made up of a plurality of identical central modules and two outer modules.
